(19) United States
(12) Patent Application Publication
(10) Pub. No.: US 2015/0319580 A1
(43) Pub. Date: Nov. 5, 2015

(54) WIRELESS POSITION ESTIMATION APPARATUS AND METHOD

(71) Applicant: SAMSUNG ELECTRO-MECHANICS CO., LTD., Suwon-si (KR)

(72) Inventors: Seong Yeon KIM, Suwon-si (KR); Hong In KIM, Suwon-si (KR)

(73) Assignee: SAMSUNG ELECTRO-MECHANICS CO., LTD., Suwon-si (KR)

(21) Appl. No.: 14/689,567

(22) Filed: Apr. 17, 2015

(30) Foreign Application Priority Data
Apr. 30, 2014 (KR) 10-2014-0052815
Nov. 10, 2014 (KR) 10-2014-0155277

(51) Int. Cl. H04W 4/02; H04W 24/08

(52) U.S. Cl. CPC H04W 4/027; H04W 24/08

(57) ABSTRACT

A wireless position estimation apparatus may include a wireless communications unit receiving radio signals including positional information related to a plurality of APs from the plurality of APs including a plurality of antennas, a radio signal processing unit combining radio signals received from the plurality of antennas or selecting one of the radio signals, depending on whether or not channel gains of the respective antennas are changed, for a respective AP, a distance calculating unit measuring received signal strength indication (RSSI) values of the radio signals combined or selected by the radio signal processing unit and calculating distance values to the APs using the measured RSSI values, and a position estimating unit estimating a position of a terminal using the calculated distance values and the positional information.

### CROSS-REFERENCE TO RELATED APPLICATIONS

This application claims priority to, and the benefit of, Korean Patent Application Nos. 10-2014-0052815 filed on Apr. 30, 2014 and 10-2014-0155277 filed on Nov. 10, 2014, with the Korean Intellectual Property Office, the disclosures of which are incorporated herein by reference.

### BACKGROUND

The present disclosure relates to a wireless position estimation apparatus and method.

Generally, in the outdoors, position may be estimated using the global positioning system (GPS). However, in interior environments, it may be difficult to obtain GPS signals, such that position may be measured using wireless communications, imaging ultrasonic waves, or the like, and comparatively precise position estimation performance is required, due to spatial limitations.

Since significant costs are required in order to introduce services capable of satisfying such demand, the introduction of indoor position based services is somewhat problematic.

According to the related art, as a method of estimating position in interior environments, there are provided a method of estimating position using a cellular network based on GPS signals and a method of estimating position using Wi-Fi signals based on the IEEE 802.11 standard.

In the method of estimating position according to the related art, a position on a map is simply estimated after received signal strength indication (RSSI) of Wi-Fi, or the like, is measured in a specific location. However, since the RSSI used to estimate the position may be temporarily changed, accuracy in estimating position may be decreased. Particularly, it may be difficult to estimate the position in buildings.

### SUMMARY

An exemplary embodiment in the present disclosure may provide a wireless position estimation apparatus and method capable of accurately determining a position of a terminal by combining a plurality of radio signals transmitted from an access point (AP) including a plurality of antennas with each other or selecting one of the radio signals to improve signal-to-noise ratios of the radio signals even in an fading environment.

According to an exemplary embodiment in the present disclosure, a wireless position estimation apparatus may include a wireless communications unit receiving radio signals including positional information related to a plurality of APs from the plurality of APs including a plurality of antennas, a radio signal processing unit combining radio signals received from the plurality of antennas with each other or selecting one of the radio signals, depending on whether or not channel gains of the respective antennas are changed, for a respective AP, a distance calculating unit measuring received signal strength indication (RSSI) values of the radio signals combined with each other or selected by the radio signal processing unit for respective APs, and calculating distance values to the APs using the measured RSSI values, and a position estimating unit estimating a position of a terminal using the distance values calculated for respective APs and the positional information.

The wireless position estimation apparatus may further include an acceleration sensor and a geomagnetism sensor, and the position estimating unit may estimate a movement speed and a movement direction of the terminal using a value measured by the acceleration sensor and a value measured by the geomagnetism sensor.

According to an exemplary embodiment in the present disclosure, a wireless position estimation apparatus may include a wireless communications unit receiving radio signals including positional information related to a plurality of APs from the plurality of APs including a plurality of antennas, a radio signal processing unit combining radio signals received from the plurality of antennas with each other or selecting one of the radio signals, depending on whether or not channel gains of the respective antennas are changed, for a respective AP, a distance calculating unit measuring RSSI values of the radio signals combined with each other or selected by the radio signal processing unit for a respective AP and calculating distance values to the APs using the measured RSSI values, an atmospheric pressure sensor measuring atmospheric pressure to generate atmospheric pressure information, and a position estimating unit estimating a three-dimensional position of a terminal using the distance values calculated for respective APs, the atmospheric pressure information, and the positional information, wherein the radio signal processing unit combines the radio signals received from the plurality of antennas with each other using an MRC method when channel gains of the plurality of antennas of the APs are changed within a preset time and selects a radio signal having a highest signal-to-noise ratio (SNR) among the radio signals received from the plurality of antennas using an antenna selection method when the channel gains of the plurality of antennas of the APs are not changed within a preset time.

According to an exemplary embodiment in the present disclosure, a wireless position estimation method may include receiving radio signals including positional information related to a plurality of APs from the plurality of APs including a plurality of antennas, combining radio signals received from the plurality of antennas with each other or selecting one of the radio signal, depending on whether or not channel gains of the respective antennas are changed, for a respective AP, measuring RSSI values of the radio signals combined with each other or selected, for a respective AP, calculating distance values to the APs using the measured RSSI values, and estimating a position of a terminal using the distance values calculated for respective APs and the positional information.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view for describing a wireless position estimation apparatus according to an exemplary embodiment in the present disclosure;

FIG. 2 is a view for describing an example of an operation in which the wireless position estimation apparatus of FIG. 1 receives radio signals from an access point (AP);

FIG. 3 is a view for describing an example of an operation in which a distance calculating unit of FIG. 1 estimates a position of a terminal;

FIG. 4 is a view for describing a wireless position estimation apparatus according to another exemplary embodiment in the present disclosure;

FIG. 5 is a view for describing an example of an operation of recalculating a changed position of a terminal;

FIG. 6 is a flow chart for describing an example of a wireless position estimation method according to an exemplary embodiment in the present disclosure;

FIG. 7 is a flow chart for describing an example of an operation of combining radio signals with each other or selecting a radio signal in FIG. 6;

FIG. 8 is a flow chart for describing an example of a wireless position estimation method according to another exemplary embodiment in the present disclosure; and

FIG. 9 is a flow chart for describing an example of a wireless position estimation method according to another exemplary embodiment in the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

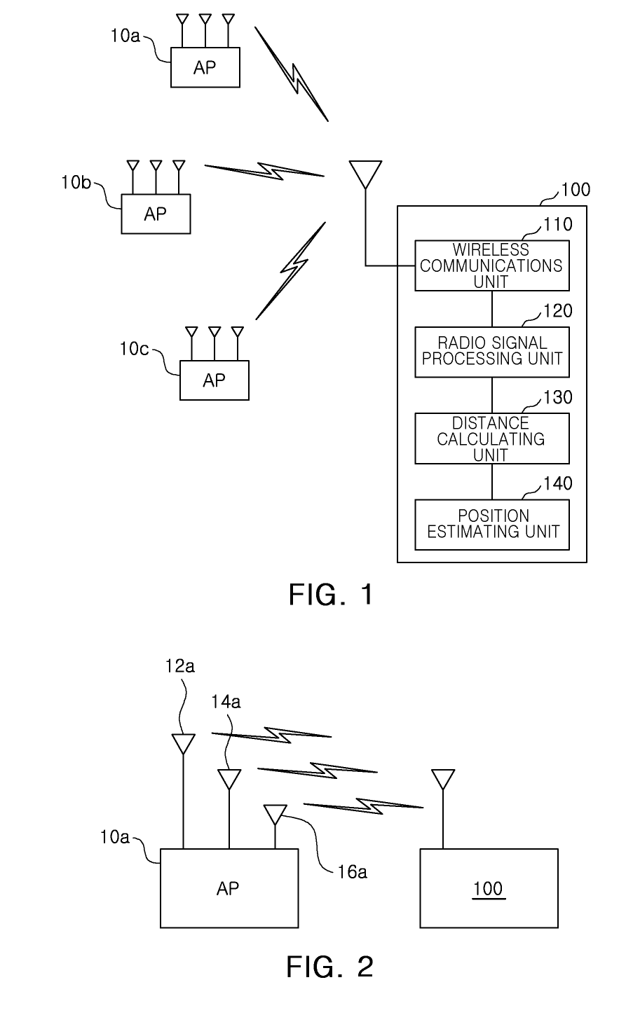

FIG. 1 is a view for describing a wireless position estimation apparatus according to an exemplary embodiment of the present disclosure; and FIG. 2 is a view for describing an example of an operation in which the wireless position estimation apparatus of FIG. 1 receives radio signals from an access point (AP).

Referring to FIG. 1, a wireless position estimation apparatus 100 according to an exemplary embodiment of the present disclosure may include a wireless communications unit 110, a radio signal processing unit 120, a distance calculating unit 130, and a position estimating unit 140.

The wireless communications unit 110 may receive radio signals including positional information related to a plurality of APs 10a, 10b, and 10c from the plurality of APs. Here, each of the plurality of APs 10a, 10b, and 10c may include a plurality of antennas, and the wireless communications unit 110 may receive the radio signals from each of the plurality of antennas.

For example, a first AP 10a may include a plurality of antennas 12a, 14a, and 16c, as illustrated in FIG. 2, and the wireless communications unit 110 may receive radio signals including positional information related to the AP 10a from each of the plurality of antennas 12a, 14a, and 16a.

The radio signal processing unit 120 may sense channel gains of each of the plurality of antennas based on the radio signals received from the plurality of antennas of the plurality of APs 10a, 10b, and 10c, and combine radio signals received for a respective AP with each other or select one of the radio signals, depending on whether or not the channel gains are changed. That is, the radio signal processing unit 120 may combine a plurality of radio signals received from a plurality of antennas of one AP 10 with each other or select one of the plurality of radio signals, thereby specifying one radio signal for calculating a distance value to the AP 10.

For example, the wireless communications unit 110 may receive radio signals including positional information related to the first AP 10a from a first antenna 12a, a second antenna 14a, and a third antenna 16a of the first AP 10a, and the radio signal processing unit 120 may combine the radio signals received from the first antenna 12a, the second antenna 14a, and the third antenna 16a with each other or select any one of the radio signals received from the first antenna 12a, the second antenna 14a, and the third antenna 16a, depending on whether or not channel gains of the first antenna 12a, the second antenna 14a, and the third antenna 16a are changed.

Here, the radio signal processing unit 120 may calculate the channel gains of each of the first antenna 12a, the second antenna 14a, and the third antenna 16a based on the radio signals received from each of the first antenna 12a, the second antenna 14a, and the third antenna 16a.

In the exemplary embodiment, in a case in which the channel gains of the plurality of antennas of the AP 10 are changed within a preset time, the radio signal processing unit 120 may combine the radio signals received from the plurality of antennas with each other using a maximal ratio combining (MRC) method.

Here, the preset time may be a time in which the radio signals are transmitted and received between the AP 10 and the wireless communications unit 110. That is, in the case in which the channel gains of the plurality of antennas of the AP 10 are changed for a period in which the wireless communications unit 110 receives the radio signals from the AP 10, the radio signal processing unit 120 may combine the radio signals received from the plurality of antennas with each other using the MRC method.

Here, the MRC method may be a method of combining the radio signals received from the antennas with each other while applying weights depending on the channel gains. The radio signals received from the plurality of antennas may be combined with each other using the MRC method to significantly decrease noise, thereby increasing signal receiving probability.

In the exemplary embodiment, in a case in which the channel gains of the plurality of antennas of the AP 10 are not changed within the preset time, the radio signal processing unit 120 may select any one of the radio signals received from the plurality of antennas using an antenna selection method.

That is, the radio signal processing unit 120 may measure signal-to-noise ratios (SNRs) of the radio signals received from the plurality of antennas and select a radio signal having the highest SNR among the plurality of radio signals received from the plurality of antennas.

In the antenna selection method as described above, when the channel gains of the antennas are changed for a time in which the radio signals are received, an improvement level of the SNR may be significantly decreased. The MRC method may be applied even though the channel gains are changed, but has a problem that current consumption is increased in a process of calculating and applying the weights.

Therefore, in the case in which the channel gains are changed for the preset time, the radio signals are combined with each other using the MRC method to improve the SNRs, whereby accuracy in estimating the position may be increased, and in the case in which the channel gains are not changed for the preset time, the radio signal having a good SNR is selected using the antenna selection method, whereby the SNR may be improved and the current consumption may be decreased.

The distance calculating unit 130 may measure received signal strength indication (RSSI) values of the radio signals specified for a respective AP 10 by the radio signal processing unit 120 and calculate distance values to the APs 10 using the measured RSSI values.

In the exemplary embodiment, distance values depending on RSSI values may be calculated in advance and be prepared in a table, and the distance calculating unit 130 may measure the RSSI values and convert the measured RSSI values into the distance value with reference to the table.

The position estimating unit 140 may estimate a position of a terminal 20 using the distance value between the AP 10 and the terminal 20 calculated by the distance calculating unit 130 and the positional information included in the radio signals.

Here, the terminal 20 may be a portable terminal apparatus including the wireless position estimation apparatus 100 according to the exemplary embodiment of the present disclosure, and a position value of the terminal 20 may be the same as that of the wireless position estimation apparatus 100.

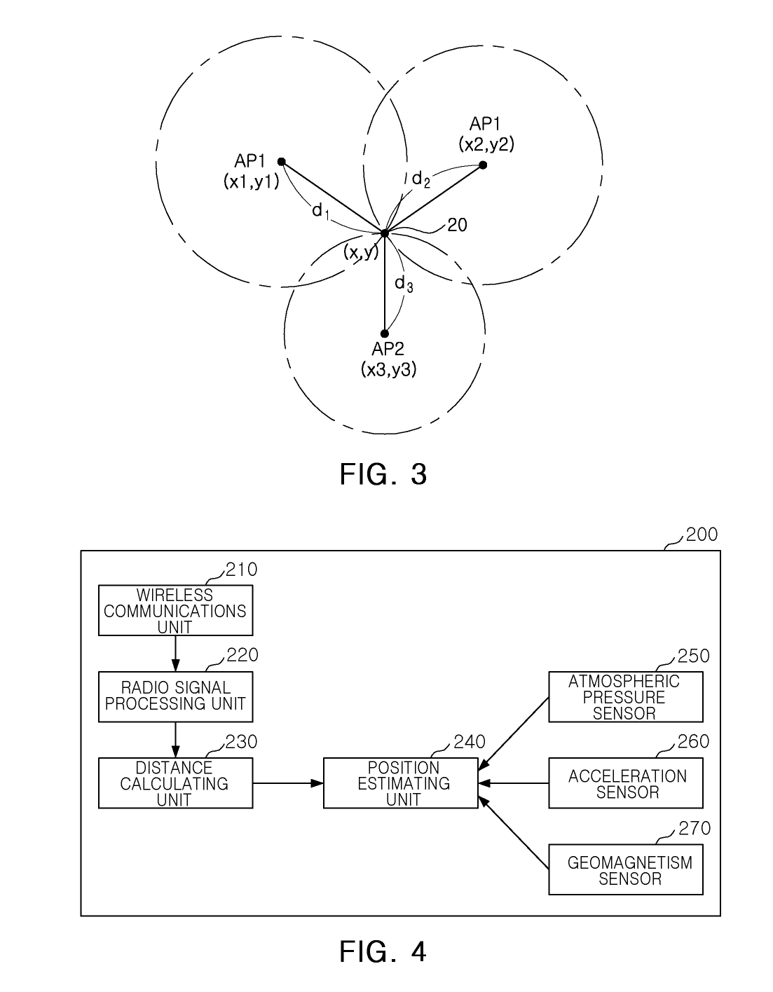

The position estimating unit 140 will be described below in more detail with reference to FIG. 3.

FIG. 3 is a view for describing an example of an operation in which a distance calculating unit of FIG. 1 estimates a position of a terminal.

Referring to FIG. 3, the distance calculating unit 130 may measure an RSSI values of the radio signal of the first AP 10a processed by the radio signal processing unit 120 and calculate a distance value d1 using the measured RSSI values. Likewise, the distance calculating unit 130 may calculate distances d2 and d3 of the second and third APs 10b and 10c.

The position estimating unit 140 may estimate a position (x, y) of the terminal 20 using the distance value d1 to the first AP 10a, the distance value d2 to the second AP 10b, the distance value d3 to the third AP 10c, positional information (x1, y1) of the first AP 10a, positional information (x2, y2) of the second AP 10b, and positional information (x3, y3) of the third AP 10c, as illustrated in FIG. 3.

Here, the positional information related to the first AP 10a, the positional information related to the second AP 10b, and the positional information related to the third AP 10c may be coordinate values corresponding to positions at which the APs are actually positioned, and may be stored in each AP 10 and be transmitted to the wireless communications unit 110 as radio signals.

According to an exemplary embodiment, the wireless position estimation apparatus 100 may include one or more processing unit and one or more memory. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

FIG. 4 is a view for describing a wireless position estimation apparatus according to another exemplary embodiment of the present disclosure.

A wireless position estimation apparatus according to another exemplary embodiment of the present disclosure illustrated in FIG. 4 may have a basic configuration similar to that of the wireless position estimation apparatus according to the exemplary embodiment of the present disclosure illustrated in FIG. 1 except that a three-dimensional position, a movement speed, and a movement direction may be estimated using an atmospheric pressure sensor 250, an acceleration sensor 260, and a geomagnetism sensor 270.

Referring to FIG. 4, a wireless position estimation apparatus 200 according to another exemplary embodiment of the present disclosure may include the wireless communications unit 210, the radio signal processing unit 220, the distance calculating unit 230, the position estimating unit 240, and the atmospheric pressure sensor 250. Here, the wireless position estimation apparatus 200 may further include the acceleration sensor 260 and the geomagnetism sensor 270.

The atmospheric pressure sensor 250 may measure atmospheric pressure to generate atmospheric pressure information. The position estimating unit 140 may receive the atmospheric pressure information from the atmospheric pressure sensor 250 and estimate a height of the terminal 20.

In the exemplary embodiment, the position estimating unit 240 may store a table including altitude information depending on the atmospheric pressure information therein, and calculate height information depending on the measured atmospheric pressure with reference to the table.

The position estimating unit 240 may estimate the height of the terminal 20 using the atmospheric pressure sensor 250 simultaneously with estimating a position of the terminal 20 on a plane using the radio signals received from the plurality of APs 10, thereby estimating three-dimensional positional information.

The acceleration sensor 260 and the geomagnetism sensor 170 may sense acceleration and a direction of the terminal 20, respectively. The position estimating unit 240 may estimate a movement speed of the terminal 20 using a value measured by the acceleration sensor 260, and estimate a movement direction of the terminal 20 using a value measured by the geomagnetism sensor 270.

According to an exemplary embodiment, the wireless position estimation apparatus 200 may include one or more processing unit and one or more memory. Here, the processing unit may include CPU (Central Processing Unit), GPU (Graphic Processing Unit), Microprocessor, ASIC (Application Specific Integrated Circuit) and FPGA (Field Programmable Gate Arrays). And the processing unit may have a plurality of cores. The memory may be a volatile memory, non-volatile memory or a combination thereof.

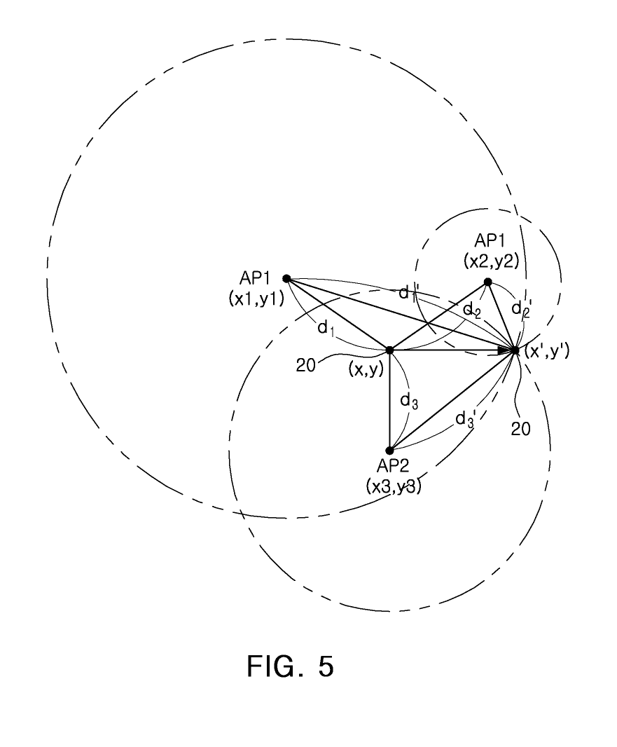

FIG. 5 is a view for describing an example of an operation of recalculating a changed position of a terminal.

Referring to FIG. 5, the position estimating unit 240 according to the exemplary embodiment of the present disclosure may recalculate distance values to the plurality of APs 10 to re-estimate a position value of the changed position, in a case in which the position of the terminal 20 is changed after the position of the terminal 20 is estimated.

Here, the position estimating unit 240 may estimate the movement direction and the movement speed of the terminal 20 using the value measured by the acceleration sensor 260 and the value measured by the geomagnetism sensor 270, and estimate the position value of the changed position using an position value of an initial position of the terminal 20 and the estimated movement direction and movement speed. The position estimating unit 240 may correct the re-estimated position value using the position value of the changed position estimated using the value measured by the acceleration sensor 260 and the value measured by the geomagnetism sensor 270.

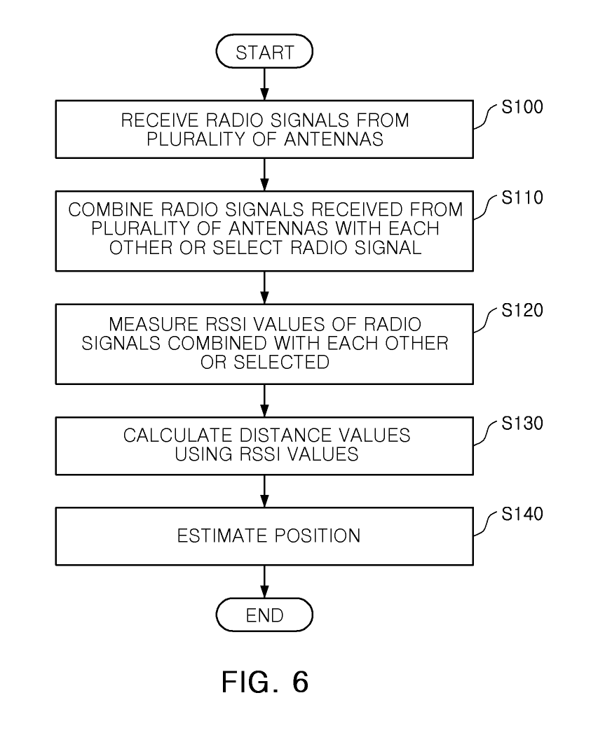

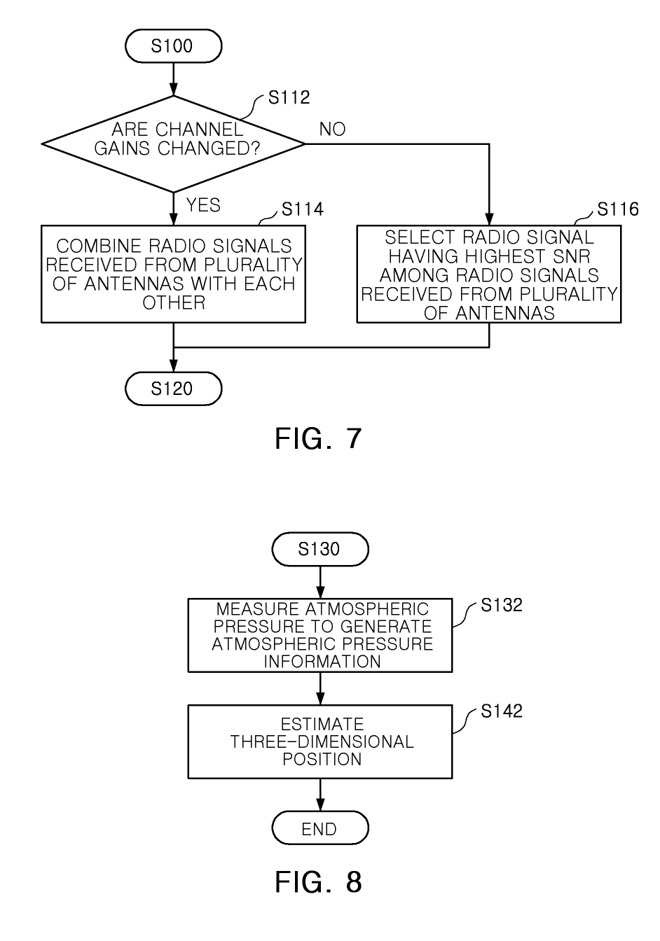

FIG. 6 is a flow chart for describing an example of a wireless position estimation method according to an exemplary embodiment of the present disclosure; and FIG. 7 is a flowchart for describing an example of an operation of combining radio signals with each other or selecting one of the radio signals in FIG. 6.

Next, a wireless position estimation method according to an exemplary embodiment of the present disclosure will be described with reference to FIGS. 6 and 7. Since the following wireless position estimation method is performed by the wireless position estimation apparatus described above with reference to FIGS. 1 through 3, a description for contents that are the same as or correspond to the above-mentioned contents will be omitted in order to avoid an overlapped description.

Referring to FIG. 6, in the wireless position estimation method according to the exemplary embodiment of the present disclosure, first, the wireless communications unit 110 may receive the radio signals including the positional information related to the plurality of APs 10 from the plurality of APs 10 including the plurality of antennas (S100).

In detail, the wireless communications unit 110 may receive the radio signals from each of the plurality of antennas included in each AP 10. Next, the radio signal processing unit 120 may combine the radio signals received from the plurality of antennas of the AP 10 for a respective AP 10 with each other or select one of the radio signals, depending on whether or not the antenna gains are changed (S110).

In other words, the wireless communications unit 110 may receive the plurality of radio signals from the plurality of antennas included in the AP 10 for one AP 10 (S100), and the radio signal processing unit 120 may combine the plurality of radio signals received for one AP 10 with each other or select one of the plurality of radio signals, depending on whether or not the antenna gains are changed, thereby processing the combined or selected signal as one radio signal (S110).

In the exemplary embodiment, in the combining of the radio signals or selecting of the radio signal, as illustrated in FIG. 7, it may be decided whether or not the channel gains of the antennas are changed for a preset time (S112), the radio signals received from the plurality of antennas may be combined with each other using the maximal ratio combining (MRC) method (S114) in the case in which the channel gains are changed, and the radio signal having the highest signal-to-noise ratio (SNR) among the radio signals received from the plurality of antennas may be selected using the antenna selection method (S116) in the case in which the channel gains are not changed.

Next, the distance calculating unit 130 may measure the received signal strength indication (RSSI) values of the radio signals combined with each other or selected by the radio signal processing unit 120 for a respective AP 10 (S120), and calculate the distance values to the APs using the measured RSSI values (S130).

Next, the position estimating unit 140 may estimate the position of the terminal 20 using the distance values calculated for respective APs 10 and the positional information (S140).

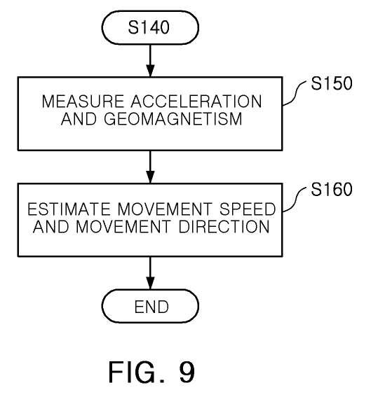

Next, a wireless position estimation method according to another exemplary embodiment of the present disclosure will be described with reference to FIGS. 8 and 9. Since the following wireless position estimation method is performed by the wireless position estimation apparatus described above with reference to FIGS. 4 and 5, a description for contents that are the same as or correspond to the above-mentioned contents will be omitted in order to avoid an overlapped description.

FIG. 8 is a flow chart for describing an example of a wireless position estimation method according to another exemplary embodiment of the present disclosure.

Referring to FIG. 8, after the distance calculating unit 230 calculates the distance to the AP 10, the atmospheric pressure sensor 250 may measure the atmospheric pressure to generate the atmospheric pressure information (S132), and the position estimating unit 240 may estimate the height of the terminal 20 using the atmospheric pressure information and estimate the three-dimensional position of the terminal 20 using the distance values to the APs 10 calculated in the calculating (S130) of the distance values and the positional information related to the APs 10 (S142).

FIG. 9 is a flow chart for describing an example of a wireless position estimation method according to another exemplary embodiment of the present disclosure.

Referring to FIG. 9, after the estimating (S140) of the position of the terminal, the acceleration sensor 260 and the geomagnetism sensor 270 may measure acceleration and geomagnetism of the terminal 20 (S150), and the position estimating unit 240 may estimate the movement speed and the movement direction using the values measured by the acceleration sensor 260 and the geomagnetism sensor 270.

As set forth above, according to the exemplary embodiments of the present disclosure, the plurality of radio signals transmitted from the APs including the plurality of antennas are combined with each other or one of the plurality of radio signals is selected to improve the SNRs of the radio signals even in a fading environment, whereby the position of the terminal may be more accurately measured.

While exemplary embodiments have been shown and described above, it will be apparent to those skilled in the art that modifications and variations could be made without departing from the scope of the present invention as defined by the appended claims.

What is claimed is:

1. A wireless position estimation apparatus comprising:
a wireless communications unit configured to receive radio signals including positional information related to a plurality of access points (APs) from the plurality of APs including a plurality of antennas;
a radio signal processing unit configured to combine radio signals received from the plurality of antennas with each other or select one of the radio signals, depending on whether or not channel gains of the respective antennas are changed, for a respective AP;
a distance calculating unit configured to measure received signal strength indication (RSSI) values of the radio signals combined with each other or selected by the radio signal processing unit for a respective AP, and calculate distance values to the APs using the measured RSSI values; and
a position estimating unit configured to estimate a position of a terminal using the distance values calculated for respective APs and the positional information.

2. The wireless position estimation apparatus of claim 1, wherein the radio signal processing unit combines the radio signals received from the plurality of antennas with each other using a maximal ratio combining (MRC) method when the channel gains of the plurality of antennas of the APs are changed within a preset time.

3. The wireless position estimation apparatus of claim 1, wherein the radio signal processing unit selects a radio signal having a highest signal-to-noise ratio (SNR) among the radio signals received from the plurality of antennas using an antenna selection method when the channel gains of the plurality of antennas of the APs are not changed within a preset time.

4. The wireless position estimation apparatus of claim 1, further comprising an atmospheric pressure sensor configured to measure atmospheric pressure to generate atmospheric pressure information,
wherein the position estimating unit estimates a height of the terminal using the atmospheric pressure information.

5. The wireless position estimation apparatus of claim 1, further comprising an acceleration sensor and a geomagnetism sensor,
wherein the position estimating unit estimates a movement speed and a movement direction of the terminal using a value measured by the acceleration sensor and a value measured by the geomagnetism sensor.

6. The wireless position estimation apparatus of claim 5, wherein the position estimating unit:
re-calculates distance values to the APs to re-estimate a position of the terminal changed due to movement of the terminal, when the movement of the terminal is sensed after the position of the terminal is estimated,
estimates the position of the terminal changed due to the movement of the terminal using the value measured by the acceleration sensor and the value measured by the geomagnetism sensor, and
corrects the re-estimated position using the position estimated using the value measured by the acceleration sensor and the value measured by the geomagnetism sensor.

7. A wireless position estimation apparatus comprising:
a wireless communications unit receiving radio signals including positional information related to a plurality of APs from the plurality of APs including a plurality of antennas;
a radio signal processing unit combining radio signals received from the plurality of antennas with each other or selecting one of the radio signals, depending on whether or not channel gains of the respective antennas are changed, for a respective AP;
a distance calculating unit measuring RSSI values of the radio signals combined with each other or selected by the radio signal processing unit for a respective AP and calculating distance values to the APs using the measured RSSI values;
an atmospheric pressure sensor measuring atmospheric pressure to generate atmospheric pressure information; and
a position estimating unit estimating a three-dimensional position of a terminal using the distance values calculated for respective APs, the atmospheric pressure information, and the positional information,
wherein the radio signal processing unit combines the radio signals received from the plurality of antennas with each other using an MRC method when channel gains of the plurality of antennas of the APs are changed within a preset time and selects a radio signal having a highest signal-to-noise ratio (SNR) among the radio signals received from the plurality of antennas using an antenna selection method when the channel gains of the plurality of antennas of the APs are not changed within the preset time.

8. The wireless position estimation apparatus of claim 7, further comprising an acceleration sensor and a geomagnetism sensor,
wherein the position estimating unit estimates a movement speed and a movement direction of the terminal using a value measured by the acceleration sensor and a value measured by the geomagnetism sensor.

9. The wireless position estimation apparatus of claim 8, wherein the position estimating unit:
re-calculates distance values to the APs to re-estimate a position of the terminal changed due to movement of the terminal, when the movement of the terminal is sensed after the position of the terminal is estimated,
estimates the position of the terminal changed due to the movement of the terminal using the value measured by the acceleration sensor and the value measured by the geomagnetism sensor, and
corrects the re-estimated position using the position estimated using the value measured by the acceleration sensor and the value measured by the geomagnetism sensor.

10. A wireless position estimation method comprising:
receiving radio signals including positional information related to a plurality of APs from the plurality of APs including a plurality of antennas;
combining radio signals received from the plurality of antennas with each other or selecting one of the radio signals, depending on whether or not channel gains of the respective antennas are changed, for a respective AP;
measuring RSSI values of the radio signals combined with each other or selected, for a respective AP;
calculating distance values to the APs using the measured RSSI values; and
estimating a position of a terminal using the distance values calculated for respective APs and the positional information.

11. The wireless position estimation method of claim 10, wherein in the combining of the radio signals received from the plurality of antennas with each other or the selecting of the radio signal, depending on whether or not the channel gains of the respective antennas are changed, for a respective AP; the radio signals received from the plurality of antennas are combined with each other using a maximal ratio combining (MRC) method when the channel gains of the plurality of antennas of the APs are changed within a preset time.

12. The wireless position estimation method of claim 10, wherein in the combining of the radio signals received from the plurality of antennas with each other or the selecting of the radio signal, depending on whether or not the channel gains of the respective antennas are changed, for a respective AP; a radio signal having a highest signal-to-noise ratio (SNR) is selected among the radio signals received from the plurality of antennas using an antenna selection method when the channel gains of the plurality of antennas of the APs are not changed within a preset time.

13. The wireless position estimation method of claim 10, further comprising, after the calculating of the distance values, measuring atmospheric pressure to generate atmospheric pressure information,
wherein in the estimating of the position, a three-dimensional position of the terminal is estimated using the distance values calculated for respective APs, the atmospheric pressure information, and the positional information.

14. The wireless position estimation method of claim 10, further comprising, after the estimating of the position, measuring acceleration and geomagnetism of the terminal; and
estimating a movement speed and a movement direction of the terminal using values of the measured acceleration and geomagnetism.
